(19) United States
(12) Patent Application Publication
(10) Pub. No.: US 2014/0168625 A1
(43) Pub. Date: Jun. 19, 2014

(54) POSITIONING APPARATUS, LITHOGRAPHY APPARATUS, AND ARTICLE MANUFACTURING METHOD

(71) Applicant: CANON KABUSHIKI KAISHA, Tokyo (JP)

(72) Inventor: Atsushi ITO, Utsunomiya-shi (JP)

(73) Assignee: CANON KABUSHIKI KAISHA, Tokyo (JP)

(21) Appl. No.: 14/132,326

(22) Filed: Dec. 18, 2013

(30) Foreign Application Priority Data
Dec. 18, 2012 (JP) 2012-275637

(51) Int. Cl. G01B 11/14

(52) U.S. Cl. CPC G01B 11/14
USPC 355/72; 356/498; 355/77

(57) ABSTRACT

Provided is a positioning apparatus including a holder configured to hold an original or a substrate and to be movable, and an interferometer for measuring a position of the holder, and positioning the holder based on an output from the interferometer. The positioning apparatus comprises a reference member provided with the holder and including a reference plane; and a plurality of measuring devices respectively configured to face the reference plane, and to respectively measure positions of a plurality of measurement points on the reference plane in a measurement direction intersecting the reference plane.

### BACKGROUND OF THE INVENTION

1. Field of the Invention

The present invention relates to a positioning apparatus, a lithography apparatus, and an article manufacturing method.

2. Description of the Related Art

A pattern is formed on a substrate by a lithography apparatus such as an exposure apparatus or the like in a lithography step included in manufacturing steps for a semiconductor device, a liquid crystal display device, and the like. For example, the exposure apparatus transfers a pattern of an original (reticle or mask) onto a photosensitive substrate (e.g., wafer, glass plate, and the like, where the surface thereof is coated with a resist layer) via a projection optical system. A lithography apparatus such as the exposure apparatus performs positioning of a stage (holder) for holding a substrate to thereby form a pattern on the substrate. A positioning apparatus that positions the stage to a desired position includes an interferometer that typically measures the position and the attitude of the stage. When the interferometer measures displacement of an object to be measured, the interferometer used for determining the origin of measurement needs to be initialized in order to specify the (absolute) position of the object to be measured.

Japanese Patent Laid-Open No. 11-195584 discloses an exposure apparatus including two TTL (Through The Lens) mark detecting systems, which simultaneously detect the reference mark provided on a mask stage and the reference mark provided on a wafer stage, provided on the upper side of the mask stage. In the exposure apparatus, the reference mark provided on the wafer stage is detected by the TTL mark detecting system via the projection optical system. The position of the wafer stage can be initialized in the direction of the optical axis (Z-axis) of the projection optical system using a contrast of signals from the reference mark provided on the wafer stage obtained by the TTL mark detecting system. In addition, the tilt attitude (inclination relative to the X-Y plane) of the wafer stage can be initialized by using a contrast of signals from two reference marks provided on the wafer stage obtained by two TTL mark detecting systems. Then, the interferometer can be initialized with the position and the attitude of the wafer stage being initialized. WO 2011/080311 discloses an exposure method (drawing method) that measures the surface height of a wafer 101 placed on a wafer stage 102 using a plurality of capacitance sensors 103 as shown in FIG. 4. These capacitance sensors 103 are arranged around an electron beam irradiating unit in order to measure a local inclination on the wafer 101 to be exposed (drawn).

Here, in the drawing apparatus that performs drawing on a substrate using an electron beam (charged particle beam), the mask stage and the TTL mark detecting system as disclosed in Japanese Patent Laid-Open No. 11-195584 are not included, and thus, the interferometer cannot be initialized by the method disclosed in Japanese Patent Laid-Open No. 11-195584.

On the other hand, even when the interferometer is initialized by using the capacitance sensor disclosed in WO 2011/080311 that measures a local inclination on a wafer, such initialization is adversely affected by span limitations between a plurality of capacitance sensors and the distortion of the wafer surface, resulting in the disadvantage of reproducibility in initialization of the wafer stage.

### SUMMARY OF THE INVENTION

The present invention provides, for example, a positioning apparatus that is advantageous to initialization of an interferometer.

According to an aspect of the present invention, a positioning apparatus including a holder configured to hold an original or a substrate and to be movable, and an interferometer for measuring a position of the holder, and positioning the holder based on an output from the interferometer is provided that comprises a reference member provided with the holder and including a reference plane; and a plurality of measuring devices respectively configured to face the reference plane, and to respectively measure positions of a plurality of measurement points on the reference plane in a measurement direction intersecting the reference plane.

Further features of the present invention will become apparent from the following description of exemplary embodiments with reference to the attached drawings.

### BRIEF DESCRIPTION OF THE DRAWINGS

FIG. 1 is a side view illustrating a configuration of a drawing apparatus according to a first embodiment of the present invention.

FIG. 2 is a plan view illustrating a configuration of a drawing apparatus as viewed from the A-A′ plane shown in FIG. 1.

FIG. 3 is a plan view illustrating a configuration of a drawing apparatus according to a second embodiment corresponding to that shown in FIG. 2.

FIG. 4 is a cross-sectional view illustrating a configuration of a drawing apparatus using a conventional capacitance sensor.

### DESCRIPTION OF THE EMBODIMENTS

Hereinafter, preferred embodiments of the present invention will be described with reference to the drawings.

### First Embodiment

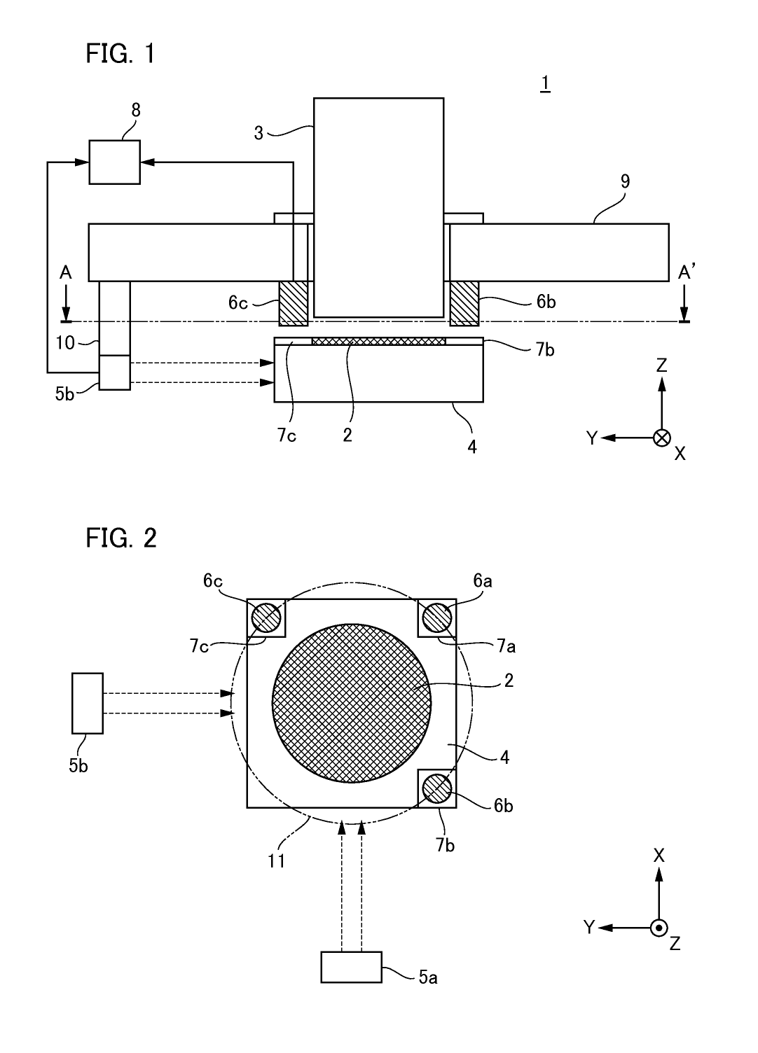

Firstly, a description will be given of a positioning apparatus according to a first embodiment of the present invention and a lithography apparatus including the positioning apparatus. The lithography apparatus is an apparatus that is used in a lithography step included in manufacturing steps for a semiconductor device, a liquid crystal display device, and the like. In the present embodiment, the lithography apparatus is a drawing apparatus as an example. The drawing apparatus deflects a single or a plurality of electron beams (charged particle beams) and controls the blanking (OFF irradiation) of electron beams to thereby draw a predetermined pattern at a predetermined position on a wafer (substrate). Here, a charged particle beam is not limited to an electron beam but may also be an ion beam. FIG. 1 and FIG. 2 are schematic views illustrating a configuration of a drawing apparatus 1 according to the present embodiment. In particular, FIG. 1 is a side view (front view) of the drawing apparatus 1 and FIG. 2 is a plan view of the drawing apparatus 1 as viewed from the A-A′ plane shown in FIG. 1. In FIG. 1 and FIG. 2, a description will be given in which the Z-axis is in a nominal irradiation direction (in the present embodiment, the vertical direction) of an electron beam to a wafer 2, and the X-axis and the Y-axis are mutually oriented in directions orthogonal to a plane perpendicular to the Z-axis. The drawing apparatus 1 has an electron beam barrel (also referred to as “electron optical barrel” or “charged particle optical barrel”) 3, a substrate stage 4 for holding the wafer 2, an interferometer 5 for measuring the position of the substrate stage 4, measuring devices 6, measuring targets 7, and a controller 8. Here, the wafer 2 is an object to be treated consisting, for example, of single crystal silicon. A photosensitive resist (photosensitizer) is coated on the surface of the wafer 2.

The electron beam barrel 3 includes therein an optical system (not shown) that deflects, emits, and focuses the electron beam that has been emitted from an electron gun or a crossover. The electron gun emits an electron (electron beam) by applying heat or an electric field. The optical system includes an electrostatic lens, a blanking deflector that can shield an electron beam, a stopping aperture, a deflector that deflects an image in a specific direction on the surface of the wafer 2, and the like. The electron beam barrel 3 is supported by a support 9, and the support 9 is fixed via a column or the like to the floor surface plate (not shown) laid on the floor. In order to prevent or reduce the attenuation of an electron beam and high voltage discharge between elements constituting the charged particle optical system, the internal pressure of the electron beam barrel 3 is adjusted to a predetermined high vacuum by a vacuum exhaust system (not shown).

The substrate stage (holder) 4 is movable in all six directions (in other words, six degrees of freedom) of X-, Y-, Z-axis directions and θx-, θy-, θz-rotational directions about the respective axes by a drive mechanism (not shown) while holding the wafer 2 by, for example, an electrostatic force. The substrate stage 4 is also installed in a chamber (not shown) and the internal pressure of the chamber is also adjusted by the vacuum exhaust system.

In order to measure the position of the substrate stage 4 in six directions, in particular, in the present embodiment, the interferometer 5 firstly includes a first interferometer 5a for X-axis direction and a second interferometer 5b for Y-axis direction each of which has three measurement axes and is installed on the support 9 via a column 10. Furthermore, the interferometer 5 includes a third interferometer for Z-axis direction (not shown). Among them, the first interferometer 5a measures the position of the substrate stage 4 in the X-axis direction, the θy rotation amount, and the θz rotation amount. On the other hand, the second interferometer 5b measures the position of the substrate stage 4 in the Y-axis direction, the θx rotation amount, and the θz rotation amount. The third interferometer measures the position of the substrate stage 4 in the Z-axis direction.

The measuring devices 6 stand facing the reference plane of the measuring targets 7 to be described below so as to measure the positions of measurement points on the reference plane in a measurement direction intersecting the reference plane. In particular, the measuring devices 6 in the present embodiment include three measuring devices, i.e., a first measuring device 6a, a second measuring device 6b, and a third measuring device 6c which are installed on the support 9. In the present embodiment, the measuring devices 6a to 6c are absolute-type capacitance sensors that measure absolute position (distance) and have an advantage in terms of low cost and space-saving.

The measuring targets 7 are reference members having the reference plane. In particular, in the present embodiment, the measuring targets 7 consist of three measuring targets 7a, 7b, and 7c that are installed on the substrate stage 4, where the three measuring targets 7a, 7b, and 7c correspond to the measuring devices 6a, 6b, and 6c, respectively. If the measuring devices 6 are capacitance sensors, it is preferable that the measuring targets 7 consist of a material having conductivity and are grounded in order to stabilize the measured values obtained by the measuring devices 6. Three groups of the measuring devices 6a to 6c and the measuring targets 7a to 7c can measure the absolute position of the substrate stage 4 in the Z-axis direction at three points on the basis of the support 9 on which the first interferometer 5a and the second interferometer 5b are installed. Note that specific installation positions of the measuring devices 6 and the measuring targets 7 will be described below.

The controller 8 is constituted, for example, by a computer or the like and is connected to the components of the drawing apparatus 1 via a line to thereby execute control of the components in accordance with a program or the like. In particular, the controller 8 of the present embodiment may perform at least positioning of the substrate stage 4 to a desired position based on the output from the interferometer 5 and initialization of the interferometer 5 based on the outputs from the measuring devices 6, which will be described below. Here, a control circuit regarding control of the positioning apparatus may be integrated with the controller 8 that integrally controls the entire drawing apparatus 1 or may also be separated from the other controller as a controller for controlling only the positioning apparatus. Also, the controller 8 may be integrated with the rest of the drawing apparatus 1 (may be provided in a shared housing) or may be installed at a location separate from the location where the rest of the drawing apparatus 1 is installed (may be provided in a separate housing).

In view of the aforementioned configuration, in the present embodiment, it can be mentioned that the interferometer 5, the measuring devices 6, the support 9 for supporting these components, the measuring targets 7 that are arranged on the substrate stage 4, and the controller 8 are integrally configured as a positioning apparatus that positions the substrate stage 4 to a desired position.

Next, a description will be given of calibration and initialization of the interferometer 5 in the positioning apparatus. The controller 8 determines the attitude (position) of the substrate stage 4 based on the output from the interferometer 5 to thereby position (drive) the substrate stage 4 to a desired position. Here, the interferometer 5 may produce a measurement error due to change in inclination between the interferometer optical axis and the target (e.g., reflecting mirror) in association with the attitude of the substrate stage 4. Hence, the positioning apparatus performs calibration for the output value of the interferometer 5 relative to the attitude of the substrate stage 4 prior to performing normal drawing processing. The positioning apparatus stores and refers to interferometer correction information (hereinafter simply referred to as “correction information”) such as a correction formula, a correction table, and the like obtained by the calibration, so that the positioning accuracy of the substrate stage 4 can be improved, resulting in an improvement in transfer accuracy of the drawing apparatus 1. It should be noted that correction information is typically information on the basis of the origin of the attitude of the substrate stage 4, and thus, the interferometer 5 for correctly reproducing the origin needs to be initialized in order to efficiently utilize the correction information. The interferometer 5 is typically an incremental-type length-measuring device. Thus, for example, when the electric source of the drawing apparatus 1 (or positioning apparatus) is reactivated after it is turned off, the origin of the attitude of the substrate stage 4 cannot be reproduced by the interferometer 5 only. Accordingly, the positioning apparatus of the present embodiment is based on the configuration as described above and further performs initialization of the interferometer 5 so as to satisfy the following conditions.

Firstly, the controller 8 can determine the θy attitude of the substrate stage 4 based on the measured values of the first measuring device 6a and the second measuring device 6b, which are spaced apart from each other in the X-axis direction, in the Z-axis direction and the installation spacing therebetween. Likewise, the controller 8 can determine the θx attitude of the substrate stage 4 based on the measured values of the first measuring device 6a and the third measuring device 6c, which are spaced apart from each other in the Y-axis direction, in the Z-axis direction and the installation spacing therebetween. In the present embodiment, the measuring devices 6, the first interferometer 5a, and the second interferometer 5b are supported by the same member (the support 9) as described above. In other words, the controller 8 reproduces the attitude of the substrate stage 4 based on the measured values of the measuring devices 6. Consequently, the controller 8 can also reproduce the attitude of the substrate stage 4 with respect to the first interferometer 5a and the second interferometer 5b. Thus, when the controller 8 initializes the interferometer 5 using the attitude of the substrate stage 4 in this state as the origin, correction information obtained by precalibration is suitably applicable, so that the positioning apparatus can position the substrate stage 4 with high accuracy.

Here, from the viewpoint of measuring the rotation attitude of the substrate stage 4 with high accuracy, it is preferable that the installation spacing between the measuring devices 6 is as large as possible. However, if the installation spacing is unnecessarily large, the size, particularly the XY plane size of the substrate stage 4 becomes large, resulting in an undesirable increase in the size of the entire drawing apparatus 1. Also, when the measuring targets 7 are provided on the outside of the wafer 2 on the substrate stage 4 in the configuration of capacitance sensors disclosed in WO 2011/080311 between which the installation spacing is small, the size of the substrate stage 4 also increases in this case. Thus, in the present embodiment, the measuring devices 6 are arranged as shown in FIG. 2 such that the center position of a virtual circle 11 passing through the three measurement points of three measuring targets 7a, 7b, and 7c is in the surface (within the area) of the wafer 2. Furthermore, the measuring devices 6 are arranged such that the diameter of the virtual circle 11 is greater than that of the wafer 2. Here, a virtual circle intersecting three measuring targets 7a, 7b, and 7c refers to a circle passing through three measurement points of the measuring targets 7 measured by the measuring devices 6. Note that the measurement point refers to a point within the upper surface of the measuring target 7, where the absolute position (the distance from the measuring device 6) of the measurement point is measured by the measuring device 6. The three groups of three measuring devices 6a, 6b, and 6c and three measuring targets 7a, 7b, and 7c which stand facing three measuring devices 6a, 6b, and 6c, respectively, may be located on the respective different quadrants on the substrate stage 4. Here, the quadrant refers to one of four quadrants (areas) which are defined by two straight lines orthogonally intersecting at the center of the circle 11 (may coincide with the center of the wafer 2) on the upper surface of the substrate stage 4 (holder). In FIG. 2, three measuring targets 7 are arranged at the stage corners of three quadrants, i.e., upper right, lower right, and upper left as an example. By utilizing the space defined by four corners of the substrate stage 4, the installation spacing between the measuring devices 6 can be increased without unnecessary increasing the size of the substrate stage 4.

Next, a description will be given of the procedure relating to calibration and initialization of the interferometer 5. Firstly, the controller 8 determines the origin attitude of the substrate stage 4 on the basis of the measured values of the measuring devices 6a, 6b, and 6c. Note that the origin should lie within the range which can be measured by the measuring devices 6a, 6b, and 6c and the interferometers 5a and 5b. In order to minimize the correction range, it is preferable that the origin is set near the center of the actual rotational stroke of the substrate stage 4. Next, the controller 8 performs calibration for an interferometer error with respect to the stage attitude on the basis of the origin of the substrate stage 4 and then creates correction information to thereby store it in a storage device (not shown). Then, the controller 8 reproduces the origin attitudes θx and θy of the substrate stage 4 using three measuring devices 6a, 6b, and 6c each time measurement by the interferometer 5 is interrupted upon turn-off of the electric source of the positioning apparatus, reactivation or the like to thereby initialize the measured values (Rx and Ry values) of the interferometer 5 in the attitude state of the substrate stage 4.

In this manner, the positioning apparatus of the present embodiment can reproduce the measured values of the interferometer 5 with high accuracy as in the case of calibration, so that correction information stored in the storage device can be used as it is. The positioning apparatus provides high measurement accuracy for the attitude of the substrate stage 4 and can reproduce the attitude of the substrate stage 4 as well as initialize the interferometer 5 in a short period of time as compared with the case where the attitude of the substrate stage is measured by capacitance sensors disclosed in WO 2011/080311 between which the installation spacing is small. Furthermore, when the wafer surface is measured by capacitance sensors as disclosed in WO 2011/080311, the reproducibility of the attitude of the stage for holding a wafer may be impaired by the influence of wafer surface accuracy, wafer placement error, or the like. In contrast, in the positioning apparatus of the present embodiment, the measuring devices 6 measure the measuring targets 7 installed on the substrate stage 4, resulting in an advantage of no reduction in reproducibility.

As described above, according to the present embodiment, a positioning apparatus that is advantageous for initializing an interferometer may be provided. According to the drawing apparatus (lithography apparatus) using the positioning apparatus, the stage attitude (stage position) can be measured with high accuracy, resulting in an advantage of improvement in, for example, drawing accuracy (transfer accuracy).

### Second Embodiment

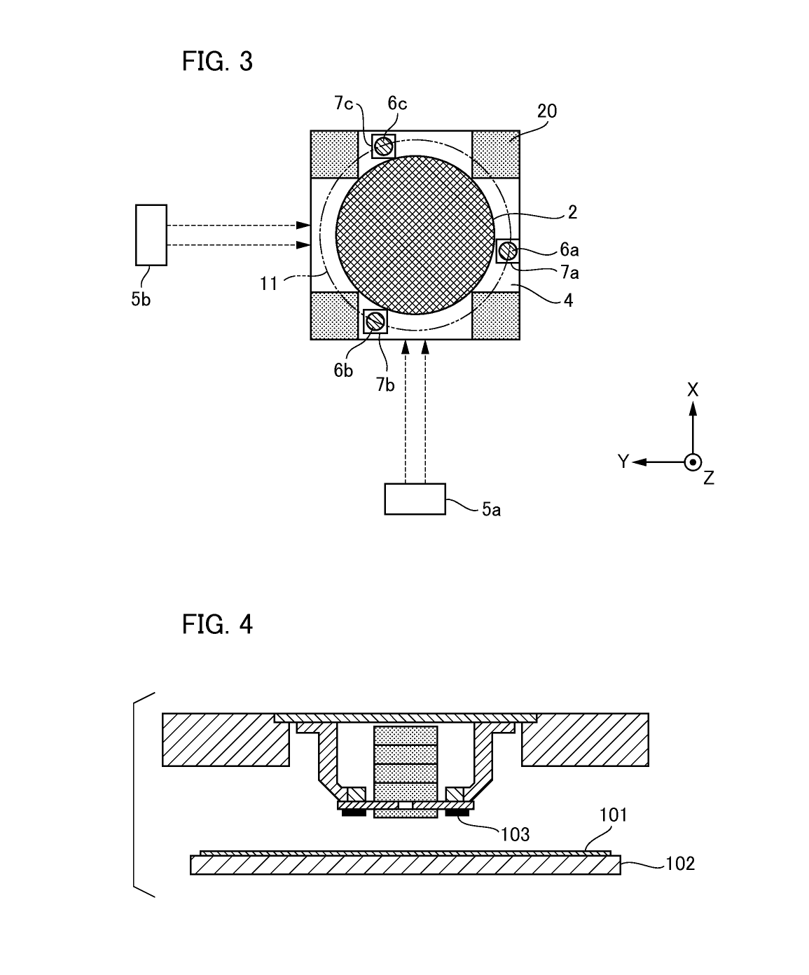

Next, a description will be given of a positioning apparatus according to a second embodiment of the present invention. A feature of the positioning apparatus of the present embodiment lies in the fact that the arrangement of the measuring devices 6 and the measuring targets 7 corresponding thereto on the substrate stage 4 is changed from the arrangement illustrated in the first embodiment. FIG. 3 is a plan view illustrating a configuration of a drawing apparatus serving as the lithography apparatus according to the present embodiment corresponding to that in the first embodiment shown in FIG. 2. For example, four corners of the substrate stage 4 may be used for other applications such as arrangement of sensors required for the lithography apparatus or the like, so that the measuring devices 6 or the measuring targets 7 may not be arranged at these positions. In this case, for example, as shown in FIG. 3, three measuring targets 7a, 7b, and 7c may be arranged on the substrate stage 4 at the stage corners of three quadrants, i.e., lower right, upper left, and lower left, respectively, so as to avoid an area (areas) 20 for arranging another kind of a sensor (sensors) at four corners of the substrate stage 4. As in the first embodiment, in the present embodiment, the measuring devices 6 are arranged such that the center position of the virtual circle 11 passing through three measuring targets 7a, 7b, and 7c lies within the upper surface of the wafer 2 and the diameter of the virtual circle 11 is greater than that of the wafer 2. According to the configuration, the installation spacing between the measuring devices 6 can be increased without unnecessary increasing the size of the substrate stage 4 as in the first embodiment. Although it is preferable that the installation spacing between two measuring devices 6 is as large as possible, in contrast to the first embodiment, in the present embodiment, it is also contemplated that it is difficult to adjust the installation spacing not to be smaller than the diameter of the wafer 2. However, the required installation spacing depends on the specification of various lithography apparatuses such as positioning accuracy or the like and the configuration of the various lithography apparatuses. Hence, the diameter condition of the virtual circle 11 may not be smaller than the radius of the wafer 2 as long as the installation spacing is satisfied with such specification and configuration.

While, in the above embodiment, capacitance sensors are employed as the measuring devices 6 which can measure the absolute position of the substrate stage 4 on the basis of the support 9, the present invention is not limited thereto. For example, the positioning apparatus may also be configured such that marks are provided on the measuring targets 7 and the images of these marks are focused on an imaging element (e.g., CCD sensor) arranged on the support 9 via an optical system. In this case, the controller 8 determines the positions of the measuring targets 7 in the Z-axis direction from a contrast of mark images obtained when the substrate stage 4 is displaced in the Z-axis direction. Also, the measuring targets 7 may be targets which can be measured by three measuring devices 6a, 6b, and 6c. Although three independent targets may be provided as shown in FIG. 2, three targets may also be constituted by a single object.

In the above embodiment, a description has been given by taking an example in which the present invention is applied to measure the position of the holder in the lithography apparatus having the holder (the substrate stage 4) movable by holding the wafer 2. In contrast, the present invention may also be applied to measure the position of the holder in the lithography apparatus having the holder movable by holding an original (mask, reticle, or mold) or the like.

Furthermore, while, in the above embodiment, a description has been given by taking an example of a drawing apparatus serving as a lithography apparatus, the lithography apparatus is not limited thereto. For example, the lithography apparatus may also be an exposure apparatus that projects a pattern of an original (reticle or mask) onto a substrate via a projection optical system using ultraviolet light or EUV light. The lithography apparatus may also be an imprint apparatus that molds an imprint material on a substrate using a mold to thereby form a pattern on the substrate. Since each of these exposure apparatus and imprint apparatus is also provided with a barrel or a mold holder instead of an electron beam barrel, the same effects may be provided if the configuration of the present embodiment is applied thereto.

### Article Manufacturing Method

An article manufacturing method according to an embodiment of the present invention is preferred in manufacturing an article such as a micro device such as a semiconductor device or the like, an element or the like having a microstructure, or the like. The article manufacturing method may include a step of forming a pattern (e.g., latent image pattern) on an object (e.g., substrate on which a photosensitive material is coated) using the aforementioned lithography apparatus; and a step of processing (e.g., step of developing) the object on which the latent image pattern has been formed in the previous step. Furthermore, the article manufacturing method may include other known steps (oxidizing, film forming, vapor depositing, doping, flattening, etching, resist peeling, dicing, bonding, packaging, and the like). The device manufacturing method of this embodiment has an advantage, as compared with a conventional device manufacturing method, in at least one of performance, quality, productivity and production cost of a device.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-275637 filed on Dec. 18, 2012, which is hereby incorporated by reference herein in its entirety.

What is claimed is:

1. A positioning apparatus including a holder configured to hold an original or a substrate and to be movable, and an interferometer for measuring a position of the holder, and positioning the holder based on an output from the interferometer, the apparatus comprising:
a reference member provided with the holder and including a reference plane; and
a plurality of measuring devices respectively configured to face the reference plane, and to respectively measure positions of a plurality of measurement points on the reference plane in a measurement direction intersecting the reference plane.

2. The positioning apparatus according to claim 1, further comprising:
a controller configured to perform initialization of the interferometer based on outputs from the plurality of measuring devices.

3. The positioning apparatus according to claim 1, wherein the plurality of measurement points have an interval, not smaller than a radius of the substrate, therebetween.

4. The positioning apparatus according to claim 1, wherein the plurality of measurement points have an interval, not smaller than a diameter of the substrate, therebetween.

5. The positioning apparatus according to claim 1, wherein the plurality of measurement points include three measurement points, a center of a circle passing through the three measurement points is in a surface of the substrate held by the holder, and a diameter of the circle is greater than a diameter of the substrate.

6. The positioning apparatus according to claim 5, wherein the three measurement points is in respective mutually different quadrants of four quadrants, which are defined, with respect to the reference plane, by two straight lines orthogonally intersecting with each other at the center.

7. The positioning apparatus according to claim 1, further comprising:
a support for supporting the interferometer and the plurality of measuring devices.

8. A lithography apparatus that forms a pattern on a substrate and comprises a positioning apparatus including a holder configured to hold an original or the substrate and to be movable, and an interferometer for measuring a position of the holder, and positioning the holder based on an output from the interferometer, the positioning apparatus comprising:
a reference member provided with the holder and including a reference plane; and
a plurality of measuring devices respectively configured to face the reference plane, and to respectively measure positions of a plurality of measurement points on the reference plane in a measurement direction intersecting the reference plane.

9. The lithography apparatus according to claim 8, further comprising:
an optical system configured to cause a charged particle beam to be incident on the substrate.

10. A method of manufacturing an article, the method comprising:
forming a pattern on a substrate using a lithography apparatus; and
processing the substrate, on which the pattern has been formed, to manufacture the article,
wherein the lithography apparatus includes a positioning apparatus including a holder configured to hold an original or the substrate and to be movable, and an interferometer for measuring a position of the holder, and positioning the holder based on an output from the interferometer, the positioning apparatus including:
a reference member provided with the holder and including a reference plane; and
a plurality of measuring devices respectively configured to face the reference plane, and to respectively measure positions of a plurality of measurement points on the reference plane in a measurement direction intersecting the reference plane.
